(19) United States
(12) Patent Application Publication
(10) Pub. No.: US 2025/0272578 A1
(43) Pub. Date: Aug. 28, 2025

(54) CONDITIONAL CONFORMAL PREDICTION INTERVALS

(71) Applicant: INTERNATIONAL BUSINESS MACHINES CORPORATION, ARMONK, NY (US)

(72) Inventors: Natalia Lucienne Martinez Gil, Ossining, NY (US); Dhavalkumar C. Patel, White Plains, NY (US); Chandrasekhara K. Reddy, Kinnelon, NJ (US); Jayant R. Kalagnanam, Briarcliff Manor, NY (US)

(21) Appl. No.: 18/586,484

(22) Filed: Feb. 25, 2024

(51) Int. Cl. G06N 5/01

(52) U.S. Cl. CPC G06N 5/01

(57) ABSTRACT

An apparatus for computing a conditional conformal prediction interval for a machine learning point prediction regression model and calibration point predictions forming a distribution of an error around the point prediction regression model in an input space. The apparatus includes a conformal regions circuit configured to compute a quantile regression of the error to compute an approximation of a quantile of the error. The conformal regions circuit is further configured to identify a set of regions in the input space where the distribution within each region in the set of regions is interpretably constant. In one embodiment, the apparatus also includes a conformal prediction circuit configured to compute the conditional conformal prediction interval for the point prediction regression model conditioned on the identified set of regions and the corresponding computed quantile of the error for each region in the set of regions.

### BACKGROUND

### Technical Field

The present disclosure generally relates to conformal predictions, and more particularly but not by way of limitation, to conditional conformal prediction intervals employing error region detection to optimize coverage of prediction point modeling subject to heteroscedastic uncertainty.

### Description of the Related Art

Machine learning regression modeling has become a valuable way of making future predictions based on historical observations. In many applications, however, it can be important to not only make accurate predictions but to also quantify the accuracy of the predictions. Conformal predictions is a technique for doing so, by constructing prediction intervals that cover a range of values around a prediction point, without need of knowing details of the machine learning algorithms or making assumptions about error distributions. Conformal predictions are particularly valuable in high-stakes decision making, such as in applications guiding the efforts in drug testing and financial investing. Conformal prediction coverage becomes more challenging where there is significant variation in the error distribution of machine learning point predictions.

### SUMMARY

According to one embodiment, a computer-implemented method is provided for computing a conditional conformal prediction interval for a machine learning point prediction regression model and calibration point predictions forming a distribution of an error around the point prediction regression model in an input space. The method includes computing a quantile regression of the error to compute an approximation of a quantile of the error. The method identifies a set of regions in the input space where the distribution within each region in the set of regions is interpretably constant. In one embodiment, the method includes computing the conditional conformal prediction interval for the point prediction regression model conditioned on the identified set of error regions and the corresponding computed quantile of the error for each region in the set of regions.

In one embodiment, an apparatus is provided for computing a conditional conformal prediction interval for a machine learning point prediction regression model and calibration point predictions forming a distribution of an error around the point prediction regression model in an input space. The apparatus includes a conformal regions circuit configured to compute a quantile regression of the error to compute an approximation of a quantile of the error. The conformal regions circuit is further configured to identify a set of regions in the input space where the distribution within each region in the set of regions is interpretably constant. In one embodiment, the apparatus also includes a conformal prediction circuit configured to compute the conditional conformal prediction interval for the point prediction regression model conditioned on the identified set of error regions and the corresponding computed quantile of the error for each region in the set of regions.

According to one embodiment, a computer system is provided for computing a conditional conformal prediction interval for a machine learning point prediction regression model and calibration point predictions forming a distribution of an error around the point prediction regression model in an input space. The computer system includes a processor, a computer-readable memory, a computer-readable tangible storage device, and program instructions stored on the computer-readable storage device for execution by a processor via the computer-readable memory. The computer system computes a quantile regression of the error to compute an approximation of a quantile of the error. In one embodiment the computer system identifies a set of regions in the input space where the distribution within each region in the set of regions is interpretably constant. The computer system further computes the conditional conformal prediction interval for the point prediction regression model conditioned on the identified set of regions and the corresponding computed quantile of the error for each region in the set of regions.

The techniques described herein may be implemented in a number of ways. Example implementations are provided below with reference to the following figures.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a block depiction of a computer hardware platform for efficiently and reliably predicting conditional conformal intervals, consistent with illustrative embodiments.

FIG. 2 diagrammatically depicts a computing environment that includes the conditional conformal prediction interval (“CCPI”) engine of FIG. 1, consistent with illustrative embodiments.

FIG. 3 graphically depicts a point prediction regression model with constant-width conformal prediction intervals, consistent with previously attempted solutions of related art.

FIG. 4 graphically depicts the regression model and conformal prediction intervals of FIG. 3, along with prediction points from calibration data demonstrating heteroscedastic uncertainty, consistent with previously attempted solutions of related art.

FIG. 5 diagrammatically depicts a horizontal-axis scatter plot representing a portion of the regression model of FIG. 4 and comparing different uncertainties in three regions of the input space for the calibration data point predictions, consistent with illustrative embodiments.

FIG. 6 diagrammatically depicts the horizontal-axis scatter plot of FIG. 5 along with computations of the 90th quantile in each of the regions of the input space, consistent with illustrative embodiments.

FIG. 7 graphically depicts the regression model of FIG. 4 but with conditional conformal prediction intervals of the present disclosure, consistent with illustrative embodiments.

FIG. 8 is a flowchart depicting a method for predicting conditional conformal intervals, consistent with illustrative embodiments.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

According to an aspect of the present disclosure, there is provided a computer-implemented method for computing a conditional conformal prediction interval for a machine learning point prediction regression model and calibration point predictions forming a distribution of an error around the point prediction regression model in an input space. In one embodiment, the method includes computing a quantile regression of the error to compute an approximation of a quantile of the error. The method furthermore identifies a set of regions in the input space where the distribution within each region in the set of regions is interpretably constant. In one embodiment, the method further includes computing the conditional conformal prediction interval for the point prediction regression model conditioned on the identified set of error regions and the corresponding computed quantile of the error for each region in the set of regions. A technical feature of the method is improved computer processing speed and reduced processing overhead by identifying the error region in which the conditional conformal prediction interval can reliably and efficiently be based on the conformal quantile objective. A technical advantage of the method is improved conformal prediction coverage without needing parametric knowledge of the error distribution.

In one embodiment, the method further computes the quantile regression of the error based on computing conformity scores for the calibration point predictions. A technical advantage of the method is improved processing capability and reduced processing overhead for the computing device.

In one embodiment, the method further computes the quantile regression of the error based on minimizing pinball loss. A technical advantage of the method is improved processing capability and reduced processing overhead for the computing device.

In one embodiment, the method further computes individual conformity scores for the calibration point predictions. A technical advantage of the method is processing scalability to score as many of the calibration point predictions as desired.

In one embodiment, the method further computes the conformity scores on a basis of absolute error of the calibration point predictions. A technical advantage of the method is processing efficiency of scoring the calibration point predictions independently of the overall error distribution.

In one embodiment, the method further includes adding the computed quantile of the error corresponding to a first region in the set of regions to the point prediction regression model and subtracting the computed quantile of the error corresponding to the first region from the point prediction regression model. A technical advantage of the method is processing efficiency of duplicating the conditional conformal prediction interval around the point prediction regression model.

In one embodiment, the method processes a first computed quantile of the error corresponding to the first region and a second computed quantile of the error corresponding to a second region in the set of regions that are different based on a predetermined confidence level. A technical feature of the method is improved processing speed and reduced processing overhead by preserving the conformal quantile objective in two different error distributions.

In one embodiment, the method further identifies the first and second regions by using a machine learning decision tree regression model. A technical advantage of the method is improved processing capability and reduced processing overhead for the computing device.

According to an aspect of the present disclosure, an apparatus is provided for computing a conditional conformal prediction interval for a machine learning point prediction regression model and calibration point predictions forming a distribution of an error around the point prediction regression model in an input space. The apparatus includes a conformal regions circuit configured to compute a quantile regression of the error to compute an approximation a quantile of the error. The conformal regions circuit is further configured to identify a set of regions in the input space where the distribution within each region in the set of regions is interpretably constant. In one embodiment, the apparatus also includes a conformal prediction circuit configured to compute the conditional conformal prediction interval for the point prediction regression model conditioned on the identified set of regions and the corresponding computed quantile of the error for each region in the set of regions. A technical feature of the apparatus is improved computer processing speed and reduced processing overhead by identifying the error region in which the conditional conformal prediction interval can reliably and efficiently be based on the conformal quantile objective. A technical advantage of the apparatus is improved conformal prediction coverage without needing parametric knowledge of the error distribution.

In one embodiment, the conformal regions circuit is configured to compute the quantile of the error based on computing conformity scores for the calibration point predictions.

In one embodiment, the conformal regions circuit is configured to compute the quantile regression of the error based on minimizing pinball loss. A technical advantage of the apparatus is improved processing capability and reduced processing overhead for the computing device.

In one embodiment, the conformal regions circuit is configured to compute individual conformity scores for the calibration point predictions. A technical advantage of the apparatus is processing scalability to score as many of the calibration point predictions as desired.

In one embodiment, the conformal regions circuit is configured to compute conformity scores based on absolute error of the calibration point predictions. A technical advantage of the apparatus is processing efficiency of scoring the calibration point predictions independently of the overall error distribution.

In one embodiment, the conformal prediction circuit is configured to add the computed quantile of the error corresponding to a first region in the set of regions to the point prediction regression model and to subtract the computed quantile of the error corresponding to the first region from the point prediction regression model. A technical advantage of the apparatus is processing efficiency of duplicating the conditional conformal prediction interval around the point prediction regression model.

In one embodiment, the conformal regions circuit is configured to identify a first computed quantile of the error corresponding to the first region and a second computed quantile of the error corresponding to a second region in the set of regions are different based on a predetermined confidence level. A technical feature of the apparatus is improved processing speed and reduced processing overhead by preserving the conformal quantile objective in two different error distributions.

In one embodiment, the conformal regions circuit is configured to identify the first and second regions based on a machine learning decision tree regression model. A technical advantage of the apparatus is improved processing capability and reduced processing overhead for the computing device.

According to an aspect of the present disclosure, there is provided a computer system for computing a conditional conformal interval for a machine learning point prediction regression model and calibration point predictions forming a distribution of an error around the point prediction regression model in an input space. The computer system includes a processor, a computer-readable memory, a computer-readable tangible storage device, and program instructions stored on the computer-readable storage device for execution by a processor via the computer-readable memory. In one embodiment, the computer system is configured to compute a quantile regression of the error to compute an approximation of the a quantile of the error. In one embodiment, the computer system identifies a set of regions in the input space where the distribution within each region in the set of regions is interpretably constant. The computer system further computes the conditional conformal prediction interval for the point prediction regression model conditioned on the identified set of regions and the corresponding computed quantile of the error for each region in the set of regions. A technical feature of the system is improved computer processing speed and reduced processing overhead by identifying the error region in which the conditional conformal prediction interval can reliably and efficiently be based on the conformal quantile objective. A technical advantage of the system is improved conformal prediction coverage without needing parametric knowledge of the error distribution.

In one embodiment, system includes computing the quantile regression of the error based on computing conformity scores for the calibration point predictions.

In one embodiment, the system includes computing the quantile regression by minimizing pinball loss. A technical advantage of the system is improved processing capability and reduced processing overhead for the computing device.

In one embodiment, the system includes identifying the first and second regions by using a machine learning decision tree regression model. A technical advantage of the system is improved processing capability and reduced processing overhead for the computing device.

Although the terms first, second, third, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It is to be understood that other embodiments can be used, and structural or logical changes can be made without departing from the spirit and scope defined by the claims. The description of the embodiments is not limiting. In particular, elements of the embodiments described hereinafter may be combined with elements of different embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

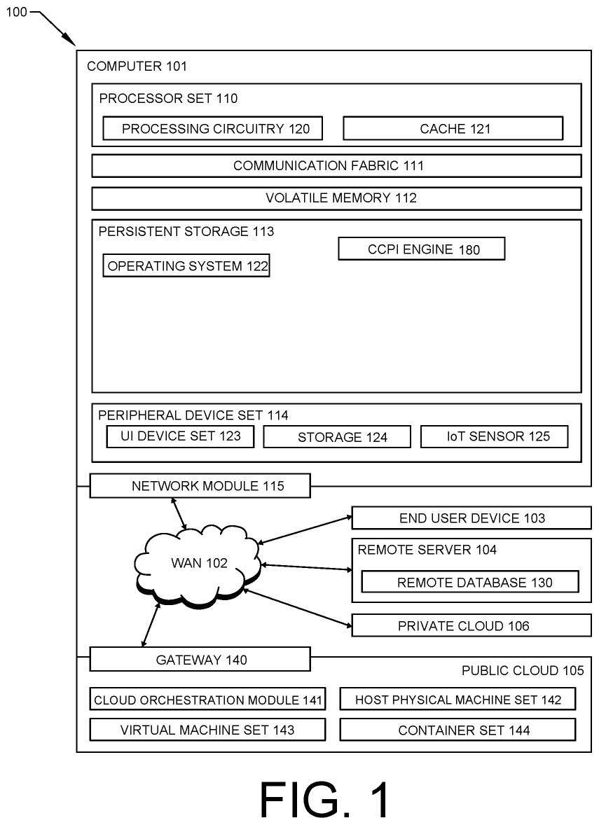

Referring to FIG. 1, environment 100 includes an example of an environment for the execution of at least some of the computer code involved in performing the inventive methods discussed herein, including a conditional conformal prediction interval (“CCPI”) engine (or block) 180. In addition to the CCPI engine 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in the CCPI engine 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Accordingly, the computing system generally facilitates signal processing in accordance with one or more embodiments illustratively described herein. For example, the signal processing can be related to artificial neural network systems, an artificial intelligence system, a collaborative filtering system, a recommendation system, a signal processing system, a word embedding system, a topic model system, an image processing system, a data analysis system, a media content system, a video-streaming service system, an audio-streaming service system, an e-commerce system, a social network system, an internet search system, an online advertisement system, a medical system, an industrial system, a manufacturing system, and/or another digital system. The system can employ hardware and/or software to solve problems that are highly technical in nature, that are not abstract and that cannot be performed as a set of mental acts by a human.

For simplicity of explanation, the specialized-computer-implemented methods are depicted and described as a series of acts. It is to be understood and appreciated that the subject innovation is not limited by the acts illustrated and/or by the order of acts. That is, for example, acts can occur in various orders and/or concurrently, and with other acts not presented and described herein. Furthermore, not all expressly disclosed acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from a computer-readable device or storage media.

The system can employ hardware and/or software to solve problems that are highly technical in nature, that are not abstract and that cannot be performed as a set of mental acts by a human. One or more embodiments of the system can also provide technical improvements to a computer processing unit associated with control signal processing by improving processing performance of the computer processing unit, reducing computing errors and computing bottlenecks of the computer processing unit, improving processing efficiency of the computer processing unit, and/or reducing an amount of time for the computer processing unit to perform a computer process.

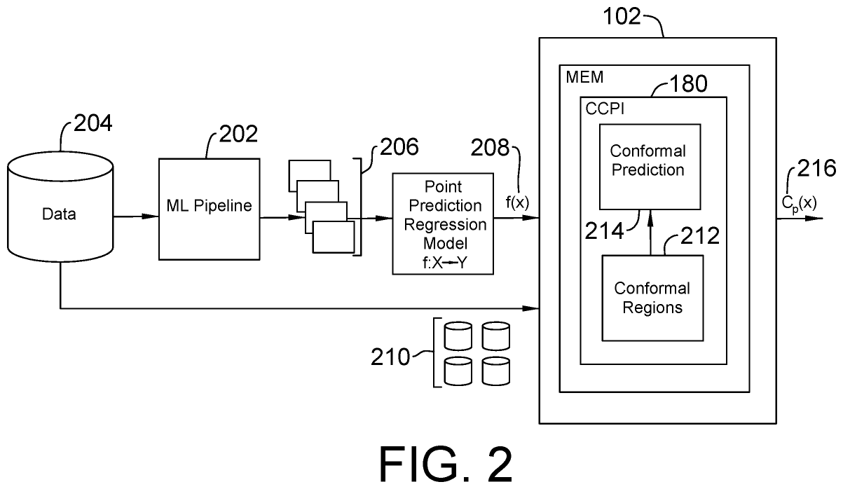

In this disclosure of illustrative embodiments, FIG. 2 diagrammatically depicts a computing environment in which the CCPI engine 180 (FIG. 1) can be stored in computer memory (“MEM”) and executed by the computer's 102 processor set 110. The MEM can be internal memory such as the persistent storage 113, or external memory accessible via a remote connection such as the WAN 102. The CCPI engine 180 can also be (in part or whole) in the virtual machine set 143 and/or container set 144.

A machine learning (“ML”) pipeline 202 can function to supply datasets from stored sample data 204 for high-speed parallel training trials in any desired number of ML models 206, consistent with illustrative embodiments. Accordingly, the computer 102 can have a specialized processing unit such as the CCPI engine 180 and the like for carrying out computations related to machine learning. More particularly, without limitation, the specialized processing unit automatically and consistently runs selected data sets on ML models 206 in order to generate point prediction regression models 208, and wraps conditional conformal prediction intervals 216 on the point prediction regression models 208 in an ML model input space.

The computer system is thereby specifically configured to provide technical improvements to data systems, machine learning systems, artificial intelligence systems, and systems of data analysis systems such as but not limited to data classification systems, data regression systems, data batching and clustering systems, and the like. The optimization can further provide one or more inferences, provide one or more predictions, and/or determine one or more relationships among the data. For example, optimization as described herein can model one or more inferences and/or predictions and/or may determine one or more relationships amongst the variables analyzed in the data. Machine learning predicts outputs, e.g., probabilities, from historical data. Such optimized machine learning helps with downstream decision making, even with such downstream decision making that is automated.

The optimization resources can employ any suitable ML based techniques, statistical-based techniques and/or probabilistic-based techniques. For example, the ML resources can employ expert systems, fuzzy logic, SVMs, Hidden Markov Models (HMMs), greedy search algorithms, rule-based systems, Bayesian models (e.g., Bayesian networks), neural networks, other non-linear training techniques, data fusion, utility-based analytical systems, and the like. For example, the ML resources can perform a set of clustering ML computations, a set of logistic regression ML computations, a set of decision tree ML computations, a set of random forest ML computations, a set of regression tree ML computations, a set of least square ML computations, a set of instance-based ML computations, a set of support vector regression ML computations, a set of k-means ML computations, a set of spectral clustering ML computations, Gaussian mixture model ML computations, a set of regularization ML computations, a set of rule ML computations, a set of Bayesian ML computations, a set of deep Boltzmann computations, a set of deep belief network computations, a set of convolution neural network computations, a set of stacked auto-encoder computations and/or a set of different ML computations.

Accordingly, the computing system generally facilitates optimizing machine learning in accordance with one or more embodiments illustratively described herein. For example, the optimizations can be related to high-speed parallel training trial systems, an artificial intelligence system, a collaborative filtering system, a recommendation system, a signal processing system, a word embedding system, a topic model system, an image processing system, a data analysis system, a media content system, a video-streaming service system, an audio-streaming service system, an e-commerce system, a social network system, an internet search system, an online advertisement system, a medical system, an industrial system, a manufacturing system, and/or another digital system. The system can employ hardware and/or software to solve problems that are highly technical in nature, that are not abstract and that cannot be performed as a set of mental acts by a human.

For simplicity of explanation, the specialized-computer-implemented methods are depicted and described as a series of acts. It is to be understood and appreciated that the subject innovation is not limited by the acts illustrated and/or by the order of acts. That is, for example, acts can occur in various orders and/or concurrently, and with other acts not presented and described herein. Furthermore, not all expressly disclosed acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from a computer-readable device or storage media.

The system can employ hardware and/or software to solve problems that are highly technical in nature, that are not abstract and that cannot be performed as a set of mental acts by a human. One or more embodiments of the system can also provide technical improvements to a computer processing unit associated with a ML process by improving processing performance of the computer processing unit, reducing computing bottlenecks of the computer processing unit, improving processing efficiency of the computer processing unit, and/or reducing an amount of time for the computer processing unit to perform the ML process.

Continuing with FIG. 2, the ML pipeline 202 can function on one end to extract data sets stored sample data 204. On the other end, the ML pipeline 202 can function to supply the data sets to high-speed parallel training trials running on many ML models 206. In between, the data pipeline can function to preprocess the data sets into proper form to run reliably on the ML models 206.

At the first end, sets of the sample data 204 can be stored in one or multiple computer memories. Extracting data sets from the sample data 204 can involve many formatting operations, such as joining data tables together and the like. Preprocessing the data sets can involve many transformative operations, such as resizing images, decoding videos, augmenting data, and the like. The preprocessing can include multiplexing a feature data stream and a label data stream into a unified complex data stream to the training trials. In an example in which the features include video images, the labels can be cross-identifications for the images, and the like. This label processing can further include transforming integer values to tensor values for performing classification modeling.

A selected set of the sample data 204 can be split into a training set of data and a calibration set of data, such as 80% in the training set and 20% in the calibration set in a nonlimiting example. The selected set of sample data 204 can be preprocessed by the ML pipeline 202 and then supplied to one or more of the ML models 206 for training to generate the point prediction regression model f(x) 208 for a selected set of independent features in the training data. The sample data 204 can also be provided to the CCPI 180, such as in memory partitions 210 as depicted in FIG. 2. The CCPI 180 can have conformal regions circuitry 212 and conformal prediction circuitry 214 configured to cooperatively compute conditional conformal prediction intervals 216.

It has been determined that the effectiveness and reliability of conformal predictions can be improved to better compensate for heteroscedastic error distributions, which is a relevant factor in accurately performing low-latency sequential operations that provide consistent results and not merely unreliable data. Some previously attempted solutions do not address heteroscedastic variations at all, and as such are penalized by poor conditional coverage in regions of changing uncertainty. Other prior attempted solutions provide overly conservative predictions from inappropriately constant or weakly varying intervals. In one aspect, the present disclosure is based on Applicant's insight that interpretable error regions of the input space can be identified to improve the conformal prediction coverage in the face of changing uncertainty by basing conditional conformal prediction intervals on quantile regression and preserving the quantile regression objective throughout all regions of heteroscedastic uncertainty.

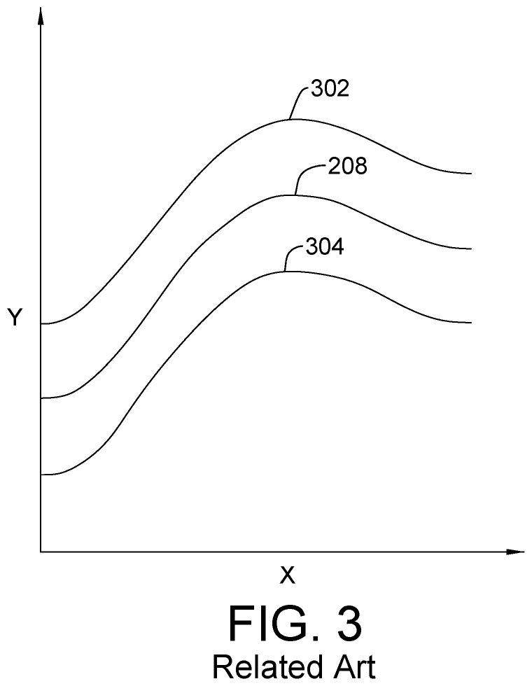

FIG. 3 graphically depicts an illustrative point prediction regression model 208 in an input space of the ML modeling, consistent with illustrative embodiments. In this illustrative example, a ML model was first trained to obtain point predictions for house prices in response to 13 input features including various factors such as crime rate, nearby industrial zoning, and tax rates. A regression of the point predictions was then performed over three of the input features—average number of rooms per house, proportion of houses built prior to 1940, and property tax rate per $10,000 in value—to obtain the point prediction regression model (“model”) 208. The model 208 in this example has a positive slope in approximately the lower half of the input space, and it transitions to a negative slope in the rest of the input space. Conformal predictions are depicted for the model 208, having an upper bound 302 and a lower bound 304 forming a constant-width prediction interval around the model 208.

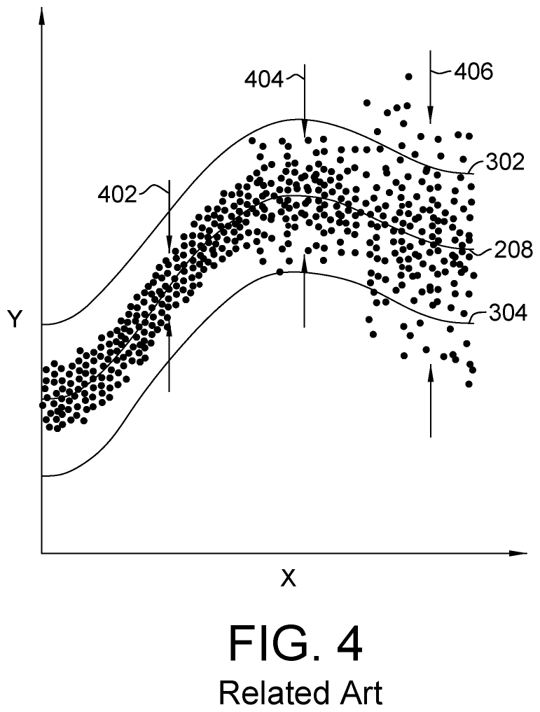

FIG. 4 depicts the model 208 and conformal predictions 302, 304 of FIG. 3, and additionally depicts a plurality of point predictions in the input space that were generated by running the calibration set of data on the machine learning model(s) 206. The overall error distribution is heteroscedastic, in that there are three interpretable regions having significantly different error distributions 402, 404, 406. By “significantly different” it is generally meant these error distributions have statistically different sample distributions such as can be measured in terms of mean, mode, standard deviation, and the like. Particularly, in the positive slope region of the model 208 the point predictions indicate a lowest error distribution 402 and along the negative slope of the model 208 the point predictions indicate a highest error distribution 406. In between, the point predictions indicate an intermediate error distribution 404. Although the constant-width conformal predictions 302, 304 can provide an overall prescribed marginal coverage for the error predictions throughout the input space, they nonetheless provide over coverage for the lowest error distribution 402 in the positive slope region of the input space and under coverage for the highest error distribution 406 in the negative slope region of the input space. The coverage disparities demonstrate an overall poor performance of the constant-width prediction interval 302, 304 in covering heteroscedastic uncertainty.

The conformal regions circuitry 212 (FIG. 2) can function to identify the interpretable regions in the input space that are distinguishable by the low, moderate, and high uncertainties. This functionality can include computing conformity scores for the point predictions. For example, given the point prediction regression model 208,

$$f : X \to Y$$

and for the calibration data set,

$${D}_{c a l} = {\{ {x}_{i} , {y}_{i} \}}_{i = 1}^{n} ∼ {p ( X , Y )}^{⊗ n}$$

conformity scores can be derived such as in terms of computing the absolute error between the point predictions and the model 208.

$$\begin{matrix}s : X , Y \to ℝ \\ s ( X , Y ) = \vert Y - f ( X ) \vert\end{matrix}$$

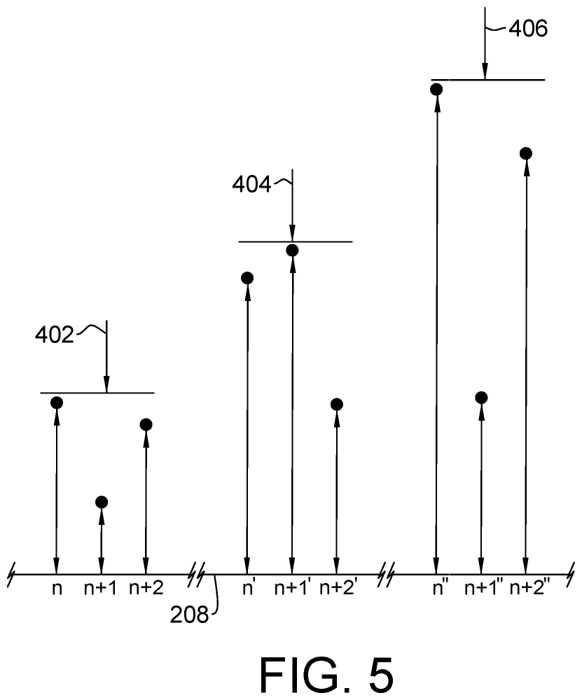

FIG. 5 is a simplified horizontal-axis scatter plot depiction of the model 208 with conformity scores individually computed in this illustrative manner for each of three calibration data point predictions in each of the interpretable error distributions 402, 404, 406. Although these illustrative embodiments disclose computing the conformity scores for consecutive point predictions, the contemplated embodiments are not so limited. In alternative embodiments less than all of the point predictions can be sampled according to any desired sampling regimen.

The conformal regions circuitry 212 (FIG. 2) can then compute a quantile regression of the conformity scores to obtain a conformal quantile of the error distribution. To begin, a conformal quantile can be estimated for the conformal scores and a selected confidence level ρ∈(0,1) such as in terms of:

$$q = \frac{⌈ ( n + 1 ) ρ ⌉}{n} - quantile ( {s ( {x}_{i} , {y}_{i} )}_{i = 1}^{n} ) ;$$

which is equivalent to the ┌(n+1)ρ┐—the smallest conformity score in the calibration dataset. In other words, q=s_{π┌(n+1)ρ┐} where π is an ascending sorting of the conformity scores such that s_{π1}<s_{π2}< . . . <s_{π┌(n+1)ρ┐}< . . . <s_{πn}.

The conditional conformal prediction interval Cp(x) 216 (FIG. 2) can be related to the selected quantile of the conformity scores, such as but not limited in terms of:

$${C}_{p} ( x ) = [ f ( x ) - q , f ( x ) + q ]$$

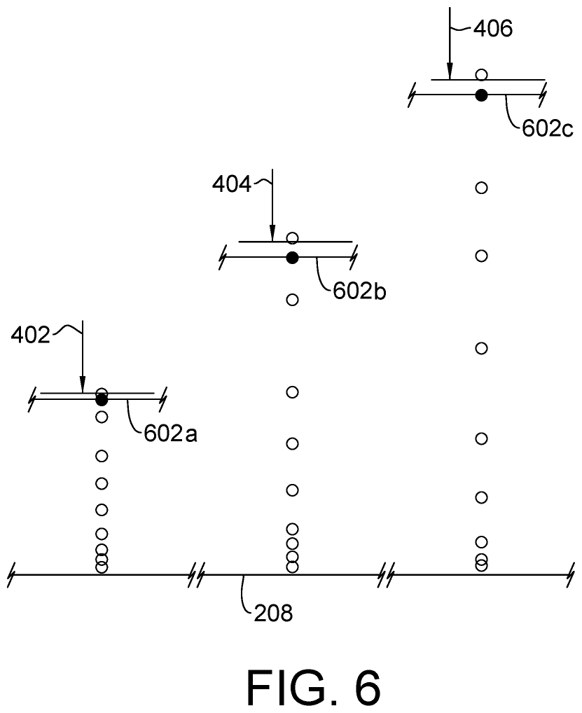

FIG. 6 depicts another horizontal-axis scatter plot similar to FIG. 5 but also diagrammatically depicting the 90th quantile 602a, 602b, 602c for each of the three respective error distributions 402, 404, 406. The 90th quantiles can be computed for any selected bucket size of point predictions in each of the regions of varying error distributions 402, 404, 406. Each 90th quantile 602a, 602b, 602c includes about 90% of the conformity scores in the corresponding error distribution 402, 404, 406. Within each region, where the error distributions 402, 404, 406 are homoscedastic, the 90th quantile 602a, 602b, 602c can model a conformal prediction that likewise provides coverage for about 90% of the conformity scores in the corresponding error distribution 402, 404, 406. But this conformal quantile objective is not preserved between different regions where the error distributions 402, 404, 406 are statistically different for a given confidence level. Thus, to preserve an overall conformal quantile objective the condition conformal prediction intervals of this disclosure can be individually conditioned on the respective region of homoscedastic uncertainty 402, 404, 406 and the corresponding portions of the conformal quantile 602a, 602b, 602c. In other words, the CCPI 180 can generate conditional conformal prediction intervals that reflect the significant changes in the quantile of the conformity scores stemming from the heteroscedastic error distribution between the interpretable regions.

By pairing the conformity scores with the point predictions and model predictions, {(xᵢ,yᵢ,sᵢ)}ᵢ₌₁ⁿ, sᵢ=s(xᵢ,yᵢ), and for a predetermined confidence level ρ∈(0,1), the conformal regions circuitry 212 (FIG. 2) can employ a set of input feature regressors and a machine learning regression tree model to provide a region prediction [symbol] (x) to the conformal prediction circuitry 214.

$$𝒯 = \{ t ( x ) = {ω}_{𝒯 ( x )} \} ( 𝒯 : X \to T , ω ∈ {ℝ}^{T} )$$

The interpretable regions can be discovered by minimizing the quantile regression loss on the conformal scores throughout the input space, such as by minimizing the pinball loss.

$${min}_{t ∈ 𝒯} {\sum }_{i = 1}^{n} {ℓ}_{ρ} ( {s}_{i} , q + t ( {x}_{i} ) ) + Ω ( t ) , {ℓ}_{ρ} ( {s}_{i} , q ) = \{ \begin{matrix}ρ \vert s - q \vert & if s > q \\ ( 1 - ρ ) \vert s - q \vert & if s \leq q\end{matrix}$$

The conformal prediction circuitry 214 (FIG. 2) can compute a conformal quantile for each interpretable region, such as in terms of the samples “c” in the region:

$${q}_{c} = \frac{⌈ ( \vert c \vert + 1 ) ρ}{\vert c \vert} - quantile ( {\{ s ( {x}_{i} , {y}_{i} ) \}}_{𝒯 ( {x}_{i} ) = c} ) ∀ c ∈ T$$

Thus, the region-based conditional conformal prediction interval 216 (FIG. 2) can be computed such as:

$${C}_{p} ( x ) = [ f ( x ) - {q}_{𝒯 ( x )} , f ( x ) + {q}_{𝒯 ( x )} ]$$

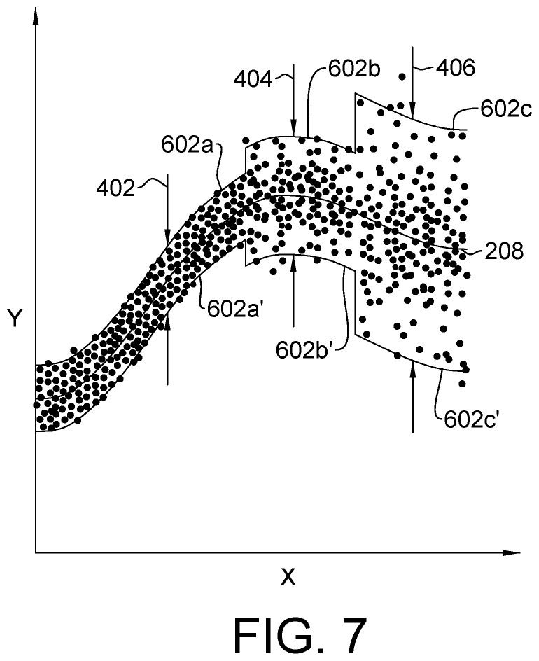

FIG. 7 depicts the sample data point predictions of FIG. 4 but with the constant-width conformal predictions 302, 304 replaced with a conditional conformal prediction intervals (Cp(x) 216 in FIG. 2) having upper bounds that can be derived by adding the 90th quantiles 602a, 602b, 602c in FIG. 6 to the model 208. Similarly, the lower bounds can be derived by subtracting the 90th quantiles 602a′, 602b′, 602c′ from the model 208. After computing the conditional conformal prediction intervals 216 of this disclosure, the ML model 208 in this example was further tested with an independent set of test data. Results of the testing favorably demonstrated that while maintaining overall marginal coverage at 95%, the worst coverage regions were improved from a coverage of about 37% to a coverage of about 90%.

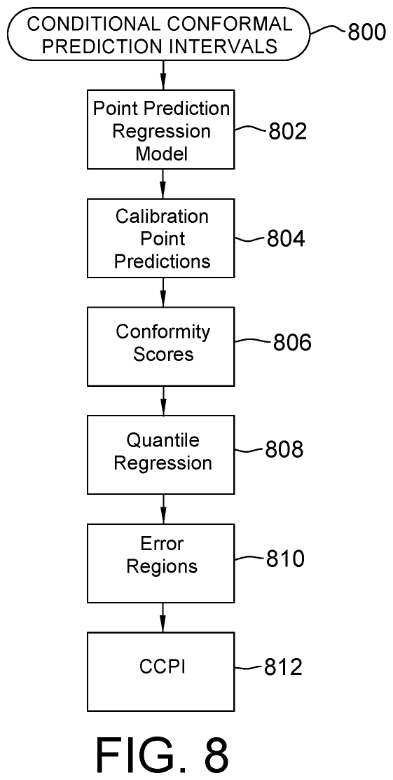

FIG. 8 is a flowchart depicting an illustrative computer-implemented method 800 for prediction conditional conformal intervals. In block 802 the method can train a machine learning model with a training set of data to generate a point prediction regression model in an input space. In block 804 the method can run a calibration set of data on the machine learning model to obtain an error distribution of point predictions around the point prediction regression model. In block 806 the method can compute conformity scores for the point predictions, such as absolute error values in the disclosure of illustrative embodiments. In block 808 the method can compute a quantile regression for the conformity scores to obtain a conformal quantile of the error distribution, such as by minimizing pinball loss in the disclosure of illustrative embodiments. In block 810 the method can identify an error region of the input space in which the error distribution is constant, such as by employing a machine learning regression tree model in the disclosure of illustrative embodiments. In block 812 the method can compute a conformal prediction interval conditioned on the error region identified in block 810 and on a portion of the conformal quantile computed in block 808 corresponding to the error region identified in block 810.

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings. The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. Numerous other embodiments are also contemplated. These include embodiments that have fewer, additional, and/or different components, steps, features, objects, benefits, and advantages. These also include embodiments in which the components and/or steps are arranged and/or ordered differently.

Aspects of the present disclosure are described herein with reference to call flow illustrations and/or block diagrams of a method, apparatus (systems), and computer program products according to embodiments of the present disclosure. It will be understood that each step of the flowchart illustrations and/or block diagrams, and combinations of blocks in the call flow illustrations and/or block diagrams, can be implemented by computer readable program instructions.

These computer readable program instructions may be provided to a processor of a computer, special purpose computer, or other programmable data processing apparatus to produce a machine, such that the instructions, which execute via the processor of the computer or other programmable data processing apparatus, create means for implementing the functions/acts specified in the call flow process and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the call flow and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the call flow process and/or block diagram block or blocks.

The flowchart and block diagrams in the Figures illustrate the architecture, functionality, and operation of possible implementations of systems, methods, and computer program products according to various embodiments of the present disclosure. In this regard, each block in the call flow process or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or call flow illustration, and combinations of blocks in the block diagrams and/or call flow illustration, can be implemented by special purpose hardware-based systems that perform the specified functions or acts or carry out combinations of special purpose hardware and computer instructions.

It is to be appreciated that the computer system (e.g., the specialized computer 101, the conditional conformal prediction interval engine 180, and/or the processing resources) performs acts involving quantile regression of heteroscedastic error distributions that cannot be performed by a human (e.g., is greater than the capability of a single human mind). For example, an amount of data processed, a speed of processing of data and/or data types of the data processed over a certain period of time can be greater, faster and different than an amount, speed and data type that can be processed by a single human mind over the same period of time. The computer system can also be fully operational towards performing one or more other functions while also performing the above-referenced signal processing functions. Moreover, signal processing output generated by computer system can include information that is impossible to obtain manually by a user. For example, an amount of information included in the signal processing output and/or a variety of information included in the signal processing output can be more complex than information obtained manually by a user.

Moreover, because at least the conditional conformal prediction intervals of this disclosure are established from a combination of electrical and mechanical components and circuitry, a human is unable to replicate or perform processing performed by the computer system (e.g., specialized computer 101, the conditional conformal prediction interval engine 180, resources) disclosed herein. For example, a human is unable to communicate data and/or process data associated with the conditional conformal prediction interval engine 180 for a given downstream task. Additionally, the specialized computer 101 significantly improves the operating efficiencies of the computer system by accurately and reliably eliminating detrimental signal amplitude instability and noise.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed:

1. A computer-implemented method for computing a conditional conformal prediction interval for a machine learning point prediction regression model and calibration point predictions forming a distribution of an error around the point prediction regression model in an input space, the method comprising:
computing a quantile regression of the error to compute an approximation of a quantile of the error;
identifying a set of regions in the input space where the distribution within each region in the set of regions is interpretably constant; and
computing the conditional conformal prediction interval for the point prediction regression model conditioned on the identified set of regions and the corresponding computed quantile of the error for each region in the set of regions.

2. The computer-implemented method of claim 1, wherein the computing a quantile regression of the error comprises minimizing pinball loss.

3. The computer-implemented method of claim 1, wherein the computing a quantile regression of the error comprises computing conformity scores for the calibration point predictions.

4. The computer-implemented method of claim 3, wherein the computing conformity scores comprises computing individual conformity scores for the calibration point predictions.

5. The computer-implemented method of claim 3, wherein the computing conformity scores comprises computing absolute error of the calibration point predictions.

6. The computer-implemented method of claim 1, wherein the computing a conditional conformal prediction interval comprises adding the computed quantile of the error corresponding to a first region in the set of regions to the point prediction regression model and subtracting the computed quantile of the error corresponding to the first region from the point prediction regression model.

7. The computer-implemented method of claim 6, wherein a first computed quantile of the error corresponding to the first region and a second computed quantile of the error corresponding to a second region in the set of regions are different based on a predetermined confidence level.

8. The computer-implemented method of claim 7, wherein the identifying the first and second regions comprises using a machine learning decision tree regression model.

9. An apparatus for computing a conditional conformal prediction interval for a machine learning point prediction regression model and calibration point predictions forming a distribution of an error around the point prediction regression model in an input space, the apparatus comprising:
a conformal regions circuit configured to:
compute a quantile regression of the error to compute an approximation of a quantile of the error;
identify a set of regions in the input space where the distribution within each region in the set of regions is interpretably constant; and
a conformal prediction circuit configured to compute the conditional conformal prediction interval for the point prediction regression model conditioned on the identified set of regions and the corresponding computed quantile of the error for each region in the set of regions.

10. The apparatus of claim 9, wherein the computing a quantile regression of the error comprises computing conformity scores for the calibration point predictions.

11. The apparatus of claim 9, wherein the conformal regions circuit is configured to compute the quantile regression of the error based on minimizing pinball loss.

12. The apparatus of claim 10, wherein the conformal regions circuit is configured to compute individual conformity scores for the calibration point predictions.

13. The apparatus of claim 10, wherein the conformal regions circuit is configured to compute conformity scores based on absolute error of the calibration point predictions.

14. The apparatus of claim 9, wherein the conformal prediction circuit is configured to add the computed quantile of the error corresponding to a first region in the set of regions to the point prediction regression model and to subtract the computed quantile of the error corresponding to the first region from the point prediction regression model.

15. The apparatus of claim 14, wherein a first computed quantile of the error corresponding to the first region and a second computed quantile of the error corresponding to a second region in the set of regions are different based on a predetermined confidence level.

16. The apparatus of claim 15, wherein the conformal regions circuit is configured to identify the first and second regions based on a machine learning decision tree regression model.

17. A computer system for computing a conditional conformal prediction interval for a machine learning point prediction regression model and calibration point predictions forming a distribution of an error around the point prediction regression model in an input space, the computer system having a processor, a computer-readable memory, a computer-readable tangible storage device, and program instructions stored on the storage device for execution by a processor via the computer-readable memory, wherein the computer system is configured to perform a method, comprising:
computing a quantile regression of the error to compute an approximation of a quantile of the error;
identifying a set of regions in the input space where the distribution within each region in the set of regions is interpretably constant; and
computing the conditional conformal prediction interval for the point prediction regression model conditioned on the identified set of regions and the corresponding computed quantile of the error for each region in the set of regions.

18. The computer system of claim 17, wherein the computing a quantile regression of the error comprises computing conformity scores for the calibration point predictions.

19. The computer system of claim 17, wherein the computing a quantile regression of the error comprises minimizing pinball loss.

20. The computer system of claim 18, wherein the identifying a set of regions comprises using a machine learning decision tree regression model.
